(19) United States
(12) Patent Application Publication
(10) Pub. No.: US 2010/0121970 A1
(43) Pub. Date: May 13, 2010

(54) method and an apparatus for streaming data containing trick play streaming modes

(75) Inventors: Joachim Roos, Nacka (SE); Karl Henriksson, Skarpnack (SE); Lukas Holm, Stockholm (SE)

Correspondence Address: NIXON & VANDERHYE, PC, 901 NORTH GLEBE ROAD, 11TH FLOOR, ARLINGTON, VA, 22203, US

(73) Assignee: EDGEWARE AB

(21) Appl. No.: 12/451,343

(22) PCT Filed: May 7, 2008
(86) PCT No.: PCT/SE2008/050529

§ 371 Date: Nov. 9, 2009

Related U.S. Application Data
(60) Provisional application No. 60/924,296, filed on May 8, 2007.

(30) Foreign Application Priority Data
May 8, 2007 (GB) 0708734.9

(51) Int. Cl. G06F 15/16

(52) U.S. Cl. 709/231

(57) ABSTRACT

The invention relates to an apparatus and a method for data streaming, the method comprising receiving a plurality of streaming requests from a plurality of user devices (11a, 11b), and streaming data according to the streaming requests, receiving a payload data flow (DC1-DC6), storing the payload data flow (DC1-DC6) during the reception of it, detecting, during the reception of the payload data flow (DC1-DC6), a plurality of identification data groups (IF1-IF7) in the payload data flow (DC1-DC6), creating, at least partly based on the identification data groups (IF1-IF7), during the reception of the payload data flow (DC1-DC6), a plurality of control data portions (1051, 1052), comprising data for linking at least some of the identification data groups (IF1-IF7), and storing, during the reception of the payload data flow (DC1-DC6), the control data portions (1051, 1052), wherein a first control data portion (1051) for a first identification data group (IF4) is stored before a second control data portion (1052) for the first identification data group (IF4) is created.

### TECHNICAL FIELD

The invention relates to an apparatus and a method for data streaming, the method comprising receiving a plurality of streaming requests from a plurality of user devices, and streaming data according to the streaming requests.

### BACKGROUND

When streaming media data during reception of it, for example in the case of TV or radio channel transmissions, it is desirable to provide the media data to end users with a minimum amount of time delay. There is also a desire in modern media data streaming applications to provide to end users possibilities of manipulating the respective data streams by allowing requests for, and streaming data at trick play modes, such as reverse and fast forward display modes, without causing substantial delays in the streaming of media data in a normal, non-trick play, viewing or listening mode.

### SUMMARY

It is an object of the invention to provide possibilities for users, to which media data flows are streamed while being received by the data streaming service provider, to obtain trick play streaming modes, while minimising delays when streaming the data flows.

This object is reached with a method for data streaming comprising
receiving a plurality of streaming requests from a plurality of user devices, and streaming data according to the streaming requests,
receiving a payload data flow,
storing the payload data flow during the reception of it,
detecting, during the reception of the payload data flow, a plurality of identification data groups in the payload data flow,
creating, at least partly based on the identification data groups, during the reception of the payload data flow, a plurality of control data portions, comprising data for linking at least some of the identification data groups, and
storing, during the reception of the payload data flow, the control data portions, wherein
a first control data portion for a first identification data group is stored before a second control data portion for the first identification data group is created.

Thus, the first control data portion can include control data that can be provided without substantial delays in the processing to the payload data flow, while the second control data portion can include data that requires further payload data flow information to be received after reception of the first identification data group. This means that the interference of the process of creating and storing control data in the streaming processes will be kept to a minimum. Thus, delays in normal streaming modes can be minimized. This is highly advantageous in many streaming applications, such as in streaming of TV channel transmissions, especially live TV transmissions, where there are requirements on keeping delays low.

Preferably, the first control data portion comprises data for linking the first identification data group to a second identification data group preceding the first identification data group, and the second control data portion comprises data for linking the first identification data group to a third identification data group following the first identification data group. Thereby, the payload data flow can comprise data for displaying a sequence of images on the user devices, the first control data portion comprising data for linking at least some of the identification data groups for at least one reverse mode in the user device, and the second control data portion can comprise data for linking at least some of the identification data groups for at least one fast forward mode in the user device.

Of course, control data links for any forward mode cannot extent further than the latest received identification data group. However, since data for linking a specific identification data group for one or more reverse modes are stored before any forward mode link for the identification data group is created, such reverse modes can be provided without substantial delay in order for end users of data streaming services to “rewind” media transmissions from any point at which it is presented in a normal viewing or listening mode.

Preferably, the identification data groups are full image data frames. Thereby, the invention is adapted to compressed visual data so that at trick play modes only frames that do not include references to previous frames for their composition (so called I-frames) are streamed.

Preferably, the method comprises creating, based on the payload data flow, a plurality of payload data subsets, wherein the step of storing the payload data flow comprises storing the payload data subsets in respective memory sectors in a memory unit, wherein the first control data portion is stored in a memory sector together with a payload data subset. Thereby, fetching payload and control data for streaming payload to user devices is simplified, since only one memory read operation is required for each payload data subset and its related control data.

Preferably, the method comprises determining, at least partly based on the identification data groups, identification data group information, and wherein the step of creating a plurality of control data portions is carried out at least partly based on the identification data group information. Thereby, the method could comprise creating, based on the payload data flow, a plurality of payload data subsets, wherein the identification data group information comprises information related to the locations in relation to respective payload data subsets. Thereby, there is no need to provide a counter, transport flow number, or similar parameter giving a “global” reference of the identification data group locations in relation to the payload data flow. This simplifies the procedure of creating the control data, and reduces the risk of errors in this process.

Preferably, the method comprises creating, based on the payload data flow, a plurality of payload data subsets, wherein the step of storing the payload data flow comprises storing the payload data subsets in respective memory sectors in a memory unit, wherein the first control data portions comprises data for linking at least some of the payload data subsets in a normal presentation mode of the payload. Thereby, the method could comprise creating, before receiving the payload data flow a memory sector address sequence for the payload data flow, and wherein the step of creating a plurality of control data portions is carried out at least partly based on the memory sector address sequence. Thereby, it is secured that links for the normal presentation mode are provided without substantial delay when the payload data flow is stored.

Preferably, where the first control data portion comprises data for streaming payload data in the payload data flow in a normal presentation mode, the method could comprise streaming payload data in the payload data flow in a normal presentation mode, and reading the first control data portion before the second control data portion is stored. Thereby advantage is taken of the multi step storage procedure according to the invention, so that time delays, from reception of the payload data flows to streaming the payload data to user devices, are minimised.

The object is also reached with an apparatus according to any of the claims 12-22.

Further, the object is reached with an apparatus for data streaming, adapted to receive a plurality of streaming requests from a plurality of user devices, and to stream data according to the streaming requests, the apparatus comprising a streaming unit, a control unit, and a memory unit,
the streaming unit being adapted to receive at least one payload data flow, to store it in the memory unit during the reception of the payload data flow, to detect, during the reception of the payload data flow, a plurality of identification data groups in the payload data flow, to determine, at least partly based on the identification data groups, identification data group information, and to send, during the reception of the payload data flow, the identification data group information to the control unit, and
the control unit being adapted create, based at least partly on the identification data group information, during the reception of the payload data flow, control data for linking at least some of the identification data groups for data streaming in at least one trick play mode.

This means that the payload does not have to be sent to the control unit. Thereby, the payload can be stored without delay that could be caused by providing control data used for trick play modes. This means that the payload is available for streaming for normal viewing or listening modes very shortly after being stored.

Preferably, the streaming unit is hard wired for receiving the payload data flow, for storing it in the memory unit, for detecting the identification data groups, for determining the identification data group information, and for sending the identification data group information to the control unit. Thereby, the payload can be stored without delay that could be caused by providing control data used for example for trick play modes. This means that the payload is available for streaming for normal viewing or listening modes very shortly after being stored.

Preferably, the apparatus is adapted to store a first control data portion for a first identification data group before creating a second control data portion for the first identification data group.

Further advantageous embodiments are given in the dependent claims 25-35.

### DESCRIPTION OF THE FIGURES

Below, embodiments of the invention will be described closer with reference to the drawing, in which

FIG. 1 is a block diagram of a data network and devices connected thereto including a data streaming device according to one embodiment of the invention,

FIG. 2 block diagram of the data streaming device in FIG. 1,

FIGS. 3a and 3b are illustrations of portions of a payload data flow,

FIG. 4 is a block diagram of a part of the data streaming device in FIG. 2,

FIG. 5a-5c show a memory sector in a memory unit in the data streaming device in FIG. 2, and

FIG. 6-8 illustrate portions of a payload data flow with linking structures.

### DETAILED DESCRIPTION

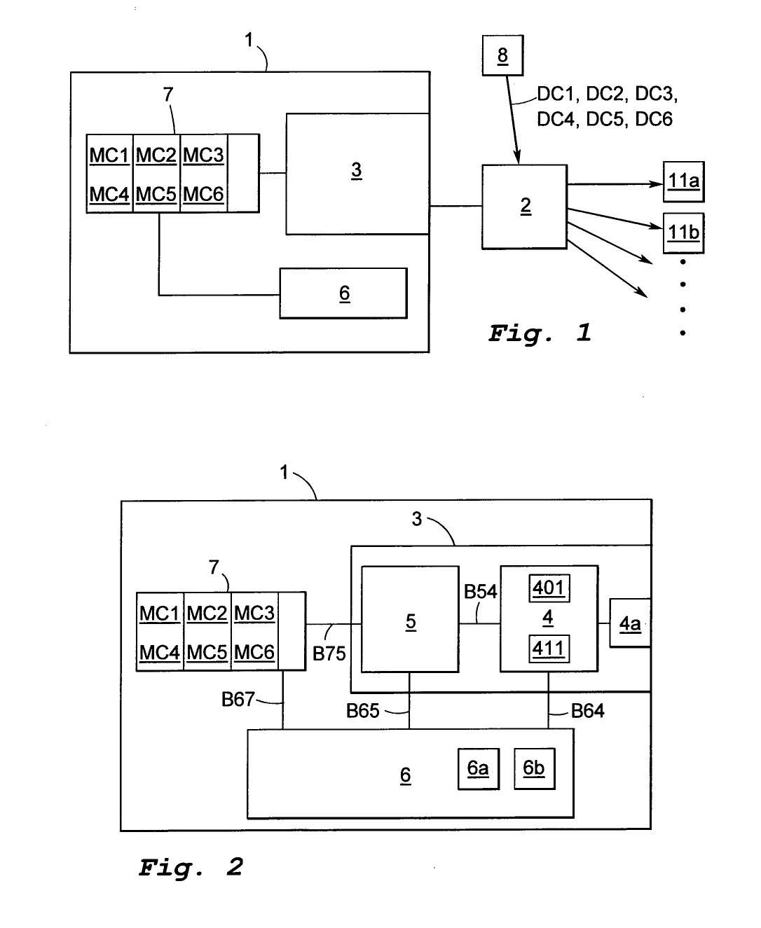

FIG. 1 depicts schematically a system with an apparatus for data streaming, herein also referred to as a data streaming device 1 for data streaming, connectable to a data network 2, e.g., in the form of an IP-network. The network can alternatively be any kind of network, global or local, suitable for transporting data. Here data refers to information in a form that can be used by a computer, router or any other component of a communications system, and it can include text, numbers, sounds, pictures, and combinations thereof.

A plurality of user devices 11a, 11b are also connectable to the network 2. The user devices 11a, 11b can be any kind of remote devices adapted to receive media data, such as set-top boxes, personal video recorders, personal computers, or any combination thereof.

This embodiment of the data streaming device 1 comprises a streaming unit 3, a control unit 6, and a memory unit 7, being connected to each other in a manner described closer below. The control unit 6 comprises a processor (CPU) and a memory. The control unit 6 can be provided in the form of a specialised unit adapted to the streaming device 1. Thereby, the memory could be a solid state memory. Alternatively, the control unit 6 can comprise some other type of memory or data storage device, for example a hard drive. In one embodiment, the control unit 6 can be provided as a standard computer with a CPU, RAM (Random access memory) and a hard drive.

The memory unit 7 may be a solid state memory unit adapted to store media payload data, e.g., in the form of multimedia sequences, for example TV channel or radio transmissions, movies, music files, and/or advertisements. More generally, the payload data can be any form of media data, whether audio, visual, text or code, provided separately or in any combination. In an embodiment of the invention, the memory unit 7 comprises a solid state memory in the form of a plurality of interconnected so-called flash memory units, i.e. in-circuit programmable non-volatile memories segmented into memory sectors, and is described closer below. Instead of flash memory units, any other suitable type of memory can be used, for example a DRAM or an SRAM.

The streaming unit 3 is adapted to read in the memory unit 7, edit and schedule data to be streamed, and send data streams to the user devices 11a, 11b via the network 2.

Reference is made to FIG. 2. In this embodiment, the streaming unit 3 of the data streaming device 1 comprises a networking unit 4, adapted to send and receive data to and from, respectively, the network 2, via a network interface 4a. The streaming unit 3 also comprises an editing unit 5 connected to the networking unit 4 by a suitable bus B54. The editing unit 5 is connected to the memory unit 7 by a bus B75. The editing unit 5 and the networking unit 4 are connected to the control unit by a respective bus B65, B64, such as a PCI (Peripheral Component Interconnect) bus.

The networking unit 4 and the editing unit 5 are hard wired (i.e. hard-coded) with each of them comprising a programmed logic device in the form of a field programmable gate array (FPGA). Alternatively, any other suitable type of programmed logic device can be used, such as programmable array logic (PAL), programmable logic device (PLD), or macrocell array.

### Pre-Processing and Storing

The data streaming device 1 is adapted to receive via the network 2 a plurality of payload data flows DC1-DC6 from a data distribution device 8. The latter can be in the form of a so called head end encoder, adapted to send by multicasting a plurality of TV channels via the network 2. Alternatively, the payload data flows DC1-DC6 can be received from the data distribution device 8 by unicast or broadcast transmissions.

In this example, each of the payload data flows DC1-DC6 corresponds to one TV channel transmission, which can include any type of programming, including live TV programs, for example displaying a sport event.

It should be noted that any of the payload flows DC1-DC6 can contain payload data sets, for example motion picture videos, as described in the patent applications GB0700311.4, GB0700313.0, GB0700343.7, and GB0700415.3, filed by the applicant and incorporated herein by reference. Such payload data sets can be received at a rate in which their contents are viewed at normal presentation (e.g. display) speed, i.e. at a real time rate.

It should also be noted that, although only one data distribution device 8 is shown in FIG. 1, alternatively, the data streaming device 1 can be adapted to receive simultaneously a plurality of payload data flows DC1-DC6 from a plurality of data distribution devices 8.

The streaming device 1 is adapted to store the payload data flows DC1-DC6 as they are received. More specifically, the streaming device is adapted to store the payload data flows DC1-DC6 in real time, continuously. Referring to FIG. 1, the control unit 6 is adapted to allocate for each of the payload flows DC1-DC6 a memory portion MC1-MC6 in the memory unit 7. Assuming that each payload data flow DC1-DC6 is received at a constant bit rate, the size of each memory portion MC1-MC6 is chosen to be adapted to the size of data received during a predetermined time interval of reception of the respective payload flow DC1-DC6. As described closer below, the data is stored in the respective memory portion in a circular manner, so that when new data is stored, old data is deleted. By adjusting the size of each memory portion MC1-MC6, the time interval during which any portion of the respective payload flow DC1-DC6 is stored can be adjusted as desired, for example to 4 hours, 3 days or 8 days.

The control unit 6 is adapted to create and store a memory address scheme, for which each memory portion MC1-MC6 of the memory unit 7 is divided into a number of memory sectors 75, each of the same size. The size of each memory sector is adapted to the size of a pair of a payload data sub-set and a control data sub-set, further described below. The scheme includes a sequence of memory sector addresses, to be followed when storing payload data sub-sets, as described below. Thus, each payload flow DC1-DC6 is allocated its own sequence of memory sector addresses. The control unit 6 is adapted to send these sequences of memory sector addresses to the networking unit 4, which is adapted to store and use them as described below.

The networking unit 4 is adapted to receive the payload data flows DC1-DC6 via the network interface 4a, and is hard coded to detect the incoming traffic of payload data flows DC1-DC6.

The networking unit 4 and the control unit 6 are adapted to pre-process the payload data flows DC1-DC6 during reception before storage. In this embodiment, the pre-processing of each payload data flow DC1-DC6 is divided into a first, second and third pre-processing stage, the first pre-processing stage being performed by the networking unit 4 and the second and third pre-processing stages being performed by the control unit 6. The networking unit 4 comprises a hard-coded first pre-processing unit 411, adapted to perform the first pre-processing stage.

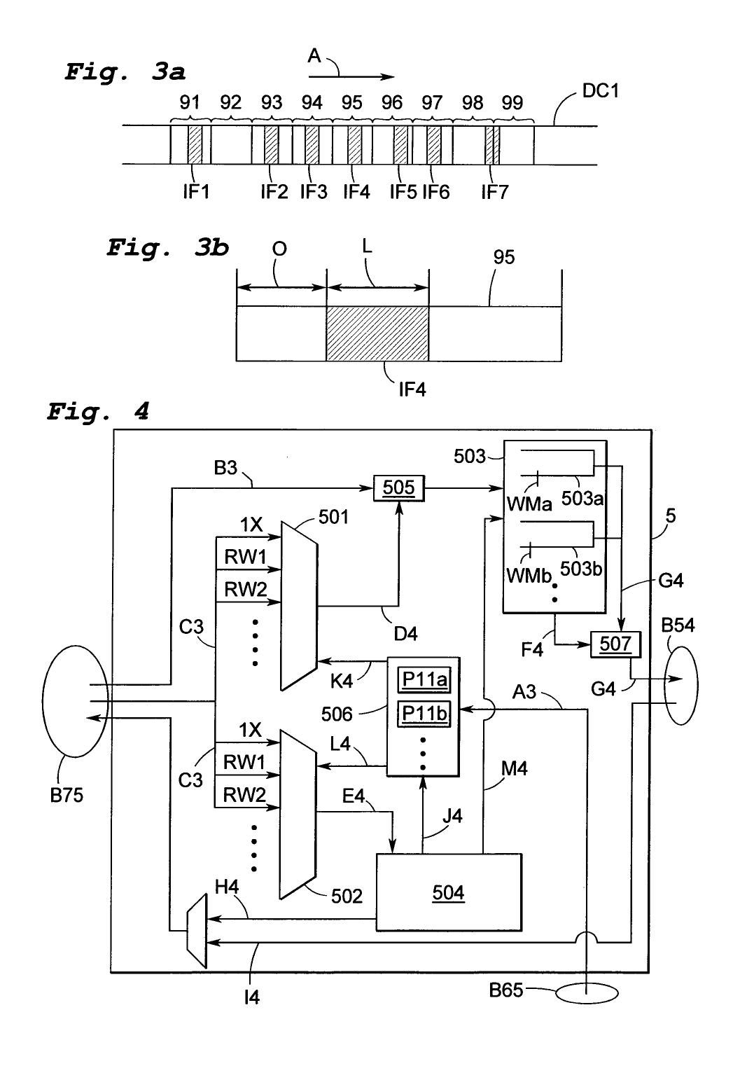

Reference is made to FIG. 3a, depicting one of the payload data flows DC1. The arrow A in FIG. 3a indicates the direction in which the payload data flow DC1 is read for being displayed in a user device at a normal presentation mode, herein also referred to as a normal viewing speed mode, (i.e. a non-trick play mode). In the first pre-processing stage, the networking unit 4 is adapted to divide the payload data flow DC1, at the rate of its reception by the networking unit 4, into a plurality of payload data sub-sets 91-99. The size of the payload data sub-sets 91-99 are the same, and adapted so that each payload data sub-set occupies a predetermined portion of a memory sector of the memory unit 7. This will leave a free space in the respective memory sector for a control data sub-set, provided as described below.

Based on the above described memory sector address sequences for the respective payload data flow, the networking unit 4 is adapted to send, again at the rate of reception of the respective payload data flows DC1-DC6, the payload data sub-sets 91-99 consecutively to the editing unit 5, them which is adapted to forward, based on the respective memory sector address sequence, for storage in respective memory sectors of the memory unit 7. More specifically, referring to FIG. 2 and FIG. 4, (FIG. 4 being a block diagram depicting functions of the editing unit 5), the networking unit 4 is adapted to send the payload data via the bus B54 to the editing unit 5, which is adapted to forward it to the memory unit 7 via the bus B75, as indicated by the arrow 14 in FIG. 4.

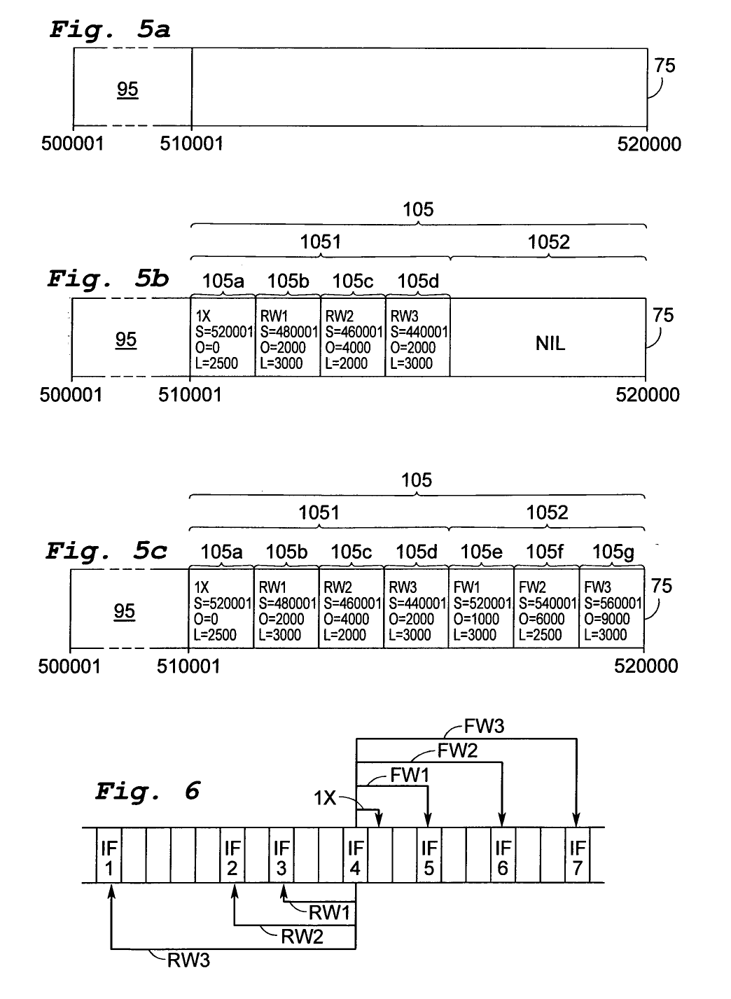

Referring to FIG. 5a, a payload data subset 95 is depicted as stored in a memory sector 75, the payload data subset 95 occupying in this example 10000 bytes of a total of 20000 bytes of the memory sector 75.

Referring again to FIG. 3a, the networking unit 4 is adapted to detect, in the first pre-processing stage, a plurality of identification data groups IF1-IF7, (herein also referred to as identifying positions), within each payload data flow DC1-DC6, and to determine data corresponding to the location and size of each identification data group IF1-IF7 within the payload data set. In this embodiment, each identification to data group IF1-IF7 corresponds to a full data frame IF1-IF7, such as a full image data frame IF1-IF7, e.g., a frame that does not include any reference to previous or other frames for their composition. More specifically, TV transmissions and videos can be compressed or coded, for example by MPEG-2, and the user devices 11a, 11b can be adapted to decode them. In MPEG-2, full image data frames are referred to as I-frames (intra coded frames). The identification of locations and sizes of the full image data frames IF1-IF7 makes it possible to provide, as described closer below, for only such full image data frames IF1-IF7 to be streamed at higher playback speeds.

It should be noted that the division of the payload data flows DC1-DC6 are performed independently of the identification data groups IF1-IF7. As a result, a identification data group IF1-IF7 can be confined within a payload data subset 91-99, a identification data group IF1-IF7 can extend from one payload data subset 91-99 to another payload data sub-set 91-99, (“bridging” two or more payload data subsets), or a payload data sub-set 91-99 can present no identification data group IF1-IF7 or portion thereof.

Referring to FIG. 3b, in this embodiment the location of each identification data group IF4 is represented by an offset value O, measured in bytes, from the beginning of the payload data sub-set 95 in which the identification data group IF4 begins. The size of each identification data group IF4 is represented by a length value L starting from the beginning of the identification data group IF4. In an alternative embodiment, the location and/or the size of each identification data group IF4 can be represented with reference to the “global” position in the payload data flow DC1, for example by using a transport flow number.

The networking unit 4 is adapted to send continuously at the rate of reception of the respective payload data flows DC1-DC6 to the control unit 6 payload data flow information. This payload data flow information includes data identifying the individual payload data sub-sets 91-99, their respective memory sectors 75, and any data corresponding to the location O and size L of any identification data group IF1-IF7 in the respective payload data sub-sets 91-99.

The control unit 6 is adapted to create, in the second and third pre-processing stages, at least partly based on the location and size data O, L for the identification data groups control data, here also referred to as side information. More specifically, the control unit 6 is adapted to create for each payload data flow DC1-DC6 control data, at a rate corresponding to the rate of reception of the respective payload data flow DC1-DC6. The control data comprises data for linking the payload data sub-sets 91, or parts thereof, when streaming the respective payload data flow DC1-DC6 to users.

As stated, the payload data flows DC1-DC6, requested by the user devices 11a, 11b can be TV channel transmissions. The control data may provide a linking structure for each playback mode that can be requested, e.g. normal viewing speed mode 1×, and trick-play modes including three fast forward modes FW1, FW2, FW3, and three fast reverse modes RW1, RW2, RW3.

As described closer below, each payload data flow comprises as in known in the art data for displaying sequentially a plurality of picture frames in the user devices. At the trick play modes, the linking structure selects and indicates the frames that are to be streamed. For example, after a frame which is not the last in a payload data sub-set, a frame in another payload data sub-set can be streamed. Also, the subsequent frame can be included in a payload data sub-set which does not follow immediately in a normal viewing speed mode. In this embodiment, as stated above, in compressed videos and at higher playback speeds only frames that do not include references to previous frames for their composition (I-frames) are streamed. This means that the speed of display at trick play modes, compared to normal playback speed, is dependent upon the density of the I-frames within the payload data flows.

Reference is made to FIG. 6. The control unit 6 is adapted to create linking information such that, in the slowest trick-play modes, FW1, RW1, all identification data groups IF1-IF7 (I-frames) are streamed without payload data between the identification data groups IF1-IF7, in second trick-play modes, FW2, RW2, faster that the slowest trick play modes, FW1, RW1, only every second identification data group IF1-IF7 is streamed, and in third trick-play modes, FW3, RW3, faster that the is second modes, FW2, RW2, only every third identification data group IF1-IF7 is streamed. Of course, alternatives to this arrangement of the trick play modes can be provided. For example, more or less than six trick play modes can be arranged, and the number of “skipped” identification data groups IF1-IF7 can be varied.

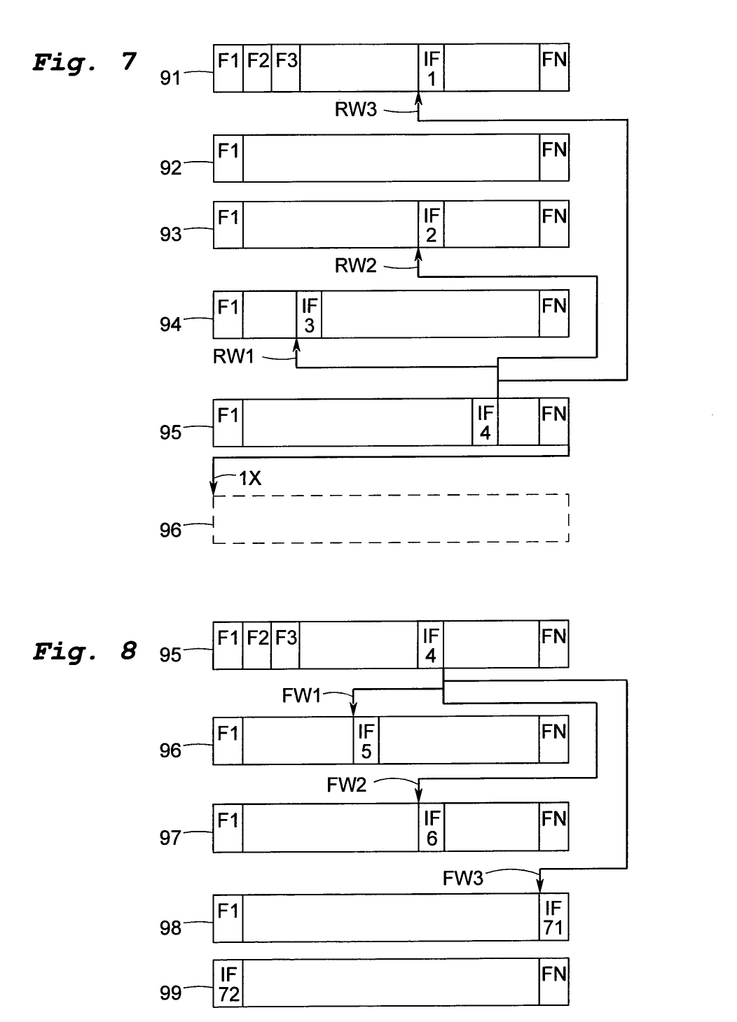

As stated, the control unit 6 continuously receives from the networking unit 4 payload data flow information. FIG. 7 illustrates an example with a series of five consecutive payload data subsets 91-95 for which the control unit 6 has received payload data flow information. More specifically, FIG. 7 illustrates a first 91, a second 92, a third 93, a fourth 94, and a fifth 95 payload data subset, the fifth payload data sub-set 95 being the sub-set for which the most recent payload data flow information was received.

The control unit 6 is adapted to create, in the second pre-processing stage, control data in the form of links for the respective payload data sub-sets 91-95, the links providing information for the normal viewing speed mode of the TV channel transmission 1×, and for the three fast reverse modes RW1, RW2, RW3. Each payload data sub-set 91-95 contains a number of picture frames F1-FN. At normal viewing speed 1× of the transmission, the linking structure provides for all frames within a payload data sub-set 91-95 to be streamed, and for the first frame F1 in a payload data sub-set to be streamed after the last frame FN of a another payload data sub-set. Therefore, the normal presentation mode link 1× for the fifth payload data sub-set 95 is determined as a pointer to the beginning of the memory sector in which the a following, sixth payload data subset 96 is to be stored, (the following payload data subset 96 being indicated with broken lines in FIG. 7). Although payload data flow information has not yet been received concerning this following payload data subset 96, its designated memory sector can be determined from the memory sector address sequence for the respective payload data flow DC1-DC6.

The control unit is adapted to store temporarily payload data flow information, including location and size data O, L for identification data groups IF1-IF3, for a predetermined number of payload data subsets 91-94. At least partly based on this stored payload data flow information, the links for the fast reverse modes RW1, RW2, RW3 are created. Thus, in this example, for a first fast reverse mode RW1, a pointer is provided from the end of an identification data group IF4 in the fifth payload data subset 95 to the beginning of an identification data group IF3 in the preceding fourth payload data subset 94. Similarly, for second and third fast reverse modes RW2, RW3, pointers are provided to identification data groups IF2, IF1 in preceding third and first payload data subsets 93, 91, respectively. As understood, in this example, for the fast reverse modes RW1, RW2, RW3, to create a full linking structure for a identification data group IF4, the control unit 6, needs to store location and size data O, L related to three preceding identification data groups IF1-IF3.

Referring to FIG. 2, the control unit 6 is adapted to send the control data to the memory unit 7 via a bus B67. Each control data subset is stored, as described below, in the free space of a memory sector 75, in which also a payload data set, related to the respective control data set, is stored. Alternatively, the control unit 6 can be adapted to send the control data to the memory unit 7 via the streaming unit 3.

Thus, referring to FIG. 5b, the streaming device 1 is adapted to store, in the memory sector 75 storing the fifth payload data subset 95, a first control data portion 1051 of a control data subset 105, which first control data portion 1051 comprises the linking information relating to the fifth payload data subset 95 for the normal presentation mode 1× and the fast reverse modes RW1, RW2, RW3. For this presentation, the first control data portion 1051 is said to comprise four edit portions 105a-105d, each providing linking information for a specific playback mode 1×, RW1, RW2, RW3

Upon storing the first control data portion 1051, the fifth payload data subset 95 can be retrieved by the streaming unit 3 in a process of streaming the payload data flows DC1-DC6 to user devices 11a, 11b, as described closer below and also in the patent applications GB0700311.4, GB0700313.0, GB0700343.7, and GB0700415.3, filed by the applicant and incorporated herein by reference. This means that the payload data flows DC1-DC6 can be streamed to user devices with a very short time delay from reception to sending by the streaming device 1.

In the third pre-processing stage, the control unit 6 creates control data comprising links providing information for the fast forward modes FW1, FW2, FW3. Of course, in the case of a payload data flow DC1-DC6 being pre-processed as received in a manner outlined here, the fast forward modes FW1, FW2, FW3 cannot extent further than the latest received identification data group IF4. Thus, for fast forward modes FW1, FW2, FW3, to create a full linking structure for each I-frame, the control unit 6, needs to store position information relating to at least three identification data groups IF5-IF7 following the identification data group IF4 for which the linking structure is to be provided.

FIG. 8 illustrates an example with a series of five consecutive payload data subsets 95-99 for which the control unit 6 has received payload data flow information. More specifically, FIG. 8 illustrates the above described fifth payload data subset 95, as well as a sixth 96, seventh 97, eighth 98 and ninth 99 payload data subset, the ninth payload data sub-set 99 being the sub-set for which the most recent payload data flow information was received.

As mentioned, the control unit 6 is adapted to store temporarily payload data flow information for a predetermined number of payload data subsets 96-99, and at least partly based on this stored payload data flow information, the links for the fast forward modes FW1, FW2, FW3 are created. Thereby, in this example, for a first fast forward mode FW1, a pointer is provided from the end of an identification data group IF4 in the fifth payload data subset 95 to the beginning of an identification data group IF5 in the following sixth payload data subset 96. Similarly, for second and third fast forward modes FW2, FW3 pointers are provided to identification data groups IF6, IF7 in the following seventh and eighth payload data subsets 97, 98, respectively.

In the example shown in FIG. 8, one of the identification data groups IF7 begins in the eighth payload data subset 98 and ends in the ninth payload data subset 99, and is therefore stored in two parts IF71, IF72 in separate payload data subsets. Therefore, the control data for the eighth payload data subset 98 will include a link to the beginning of the memory sector storing the ninth payload data subset 99.

As understood, in this example, for the fast forward trick-play modes FW1, FW2, FW3, to create a full linking structure for a identification data group IF4, the control unit 6, needs to store location and size data O, L related to three following identification data groups IF5-IF7.

Referring to FIG. 5c, the streaming device 1 is adapted to store, in the memory sector 75 storing the fifth payload data subset 95 and the first control data portion 1051, a second control data portion 1052 of the control data subset 105, which second control data portion 1052 comprises the linking information relating to the fifth payload data subset 95 for the fast forward modes FW1, FW2, FW3. Thus, after storing the second control data portion 1052, the control data subset 105 in the memory sector 75 comprises seven edit portions 105a-105g, each providing linking information for a specific playback mode 1×, RW1, RW2, RW3, FW1, FW2, FW3.

As mentioned above, the data is stored in the respective memory portion MC1-MC6 in a circular manner, so that when new data is stored, old data is deleted. By adjusting the size of each memory portion MC1-MC6, the time interval during which any portion of the respective payload flow DC1-DC6 is stored can be adjusted as desired. More specifically, the memory sectors 75 storing individual payload data subsets 91-99 are physically distributed in the memory unit 7 in any suitable manner. The above mentioned memory sector address sequence provides a sequence of all memory sectors 75 in the memory portion MC1-MC6. At the end of this sequence there will be a pointer to the first memory sector 75. This will provide the circular storage scheme of the preferred embodiment of the invention.

Referring again to FIG. 5b, the streaming device 1 is adapted to write in the memory sector 75, when storing the first control data portion 1051, a data entry, in FIG. 5b denoted “NIL”. This data entry is later deleted from the memory sector 75 when the second control data portion 1052 is stored therein. The data entry NIL indicates that further forward mode FW1, FW2, FW3 links are not provided yet. This is useful in a situation where a user device 11a, 11b has requested a fast forward mode FW1, FW2, FW3 at a location in the payload data flow, preceding the location at which data is streamed in a normal presentation mode 1×. If the fast forward mode is allowed to continue without any interruption by a user input, the data sequence being streamed will eventually reach the point where there is an interruption in the payload data flow due to further data not having yet been received and pre-processed, i.e. the fast forward streaming has “caught up” with the point at which payload is received by the streaming device 1. To avoid any errors occurring the streaming sessions, such as data stored previously is the above described cyclic use of the memory portion MC1-MC6, the data entry NIL will provide an instruction for the streaming unit 3 to perform a pre-selected mode shift, preferably into the normal presentation mode 1×.

In an alternative embodiment, the payload data sub-sets and control data sub-sets may be stored in separate portions of the memory, or even in separate memory units. Thereby, the payload data flow can be stored as an uninterrupted sequence of data, and the control data can include pointers to identification data groups guided by values of a traffic flow counter parameter or similar, and information about identification data group sizes.

Above, the control data for linking the payload data subsets 91-99 in a normal presentation mode has been presented as being provided by the control unit 6 together with the reverse mode control data. Alternatively, the normal presentation mode control data can be provided separately by the networking unit, based on the memory sector address sequence. As a further alternative, the normal presentation mode control data can be “permanently” pre-stored in the memory portions MC1-MC6, based on the memory sector address sequence.

In the embodiment described above, part of the pre-processing has been described as performed by the streaming unit 3. In an alternative embodiment, all pre-processing can be performed by the control unit 6. Thereby, the payload data flows DC1-DC6 can be sent to the control unit 6 for pre-processing before storage.

### Streaming

Below examples of functions for data streaming according to one embodiment of the invention are disclosed.

Reference is made to FIGS. 1 and 2. The networking unit 4 is adapted to receive, via the network interface 4a, from user devices 11a, 11b requests, including requests for playback modes 1×, FW1, FW2, FW3, RW1, RW2, RW3, for content in any of the payload data flows DC1-DC8. (It should be noted that the data streaming device according to a preferred embodiment of the invention is, when used in practice, able to work simultaneously with requests from up to 10000 user devices.)

The networking unit is adapted to forward the user device requests to the control unit 6, to be treated by a user request unit 6b, which is adapted to read the requests according to a protocol for media streaming requests, such as RTSP (Real Time Streaming Protocol). The user request unit 6b is adapted to process the requests, each including the identity of the respective user device 11a, 11b, the respective payload data flow DC1-DC8 and respective the playback mode request, so as to be adapted to a streaming device internal language format, and send them to the editing unit 5. The user request unit 6b is also adapted to extract from the requests sets of request data, each including the identity of the network protocol used for the respective request, and a network address of the respective user device 11a, 11b. The user request unit 6b is further adapted to send the extracted sets of request data to the networking unit 4 to be stored in networking unit storage means in the form of a RAM memory 401.

Referring to FIG. 4, the editing unit 5 comprises a user status memory 506, adapted to receive, as indicated by the arrow A3, from the control unit 6 user request information, and to store it.

Further, the editing unit 5 comprises a first and a second multiplexer 501, 502, each adapted to receive from the memory unit 7 control data sub-sets 105, as indicated by the arrows C3 in FIG. 4. The editing unit 5 also comprises a trimming device 505, as well as a pacing device 504, and a scheduling device 507. The trimming device 505 is adapted to receive from the memory unit 7 payload data subsets 91-99, as indicated by the arrow B3 in FIG. 4, upon requests from the pacing device 504. The first and second multiplexers 501, 502 are adapted to receive control data sub-sets 105 comprising at least one control data portion 1051, 1052 (FIG. 5a-5b), upon requests from the pacing device 504.

The user status memory 506 is adapted to receive periodically from the pacing device 504 data, as indicated by the arrow J4 in FIG. 4, corresponding to information regarding the user device, i.e. the stream, for which a read request is currently being sent to the memory unit 7. The user status memory 506 may comprise a plurality of rows, each corresponding to one stream according to a user request P11a, P11b, and controls the multiplexers 501, 502 for filtering the control data in accordance with the playback modes of the respective user requests. Thus, the user status memory 506 is adapted to send, in response to the stream identity information J4 from the pacing device 504, control signals, indicated by the arrows K4, L4 in FIG. 4, so as to adjust the setting of the multiplexers to the playback mode 1×, FW1, FW2, FW3, RW1, RW2, RW3 of the stream currently being served.

Thus, the first multiplexer 501 is adapted to receive control data sub-sets 105, and, in dependence on the control of the user status memory 506 concerning the requested playback mode IX, FW1, FW2, FW3, RW1, RW2, RW3, extract an edit portion 105a-105g (FIG. 5c) of each sub-set 105 of control data, which edit portion gives linking information for the requested playback mode 1×, FW1, FW2, FW3, RW1, RW2, RW3. As indicated by the arrow D4 in FIG. 4, the edit portions of the control data sub-sets 105 are used to read in the trimming device 505, so that a data sequence according to the linking structure of the respective edit portion 105a-105g of the control data sub-sets 105 is sent to an output buffer 503a, 503b of an output memory 503.

The output memory 503 is preferably a large solid state memory, and is arranged so as to provide a plurality of output buffers 503a, 503b, in the form of FIFO (first-in, first-out) queues, corresponding to the plurality of user devices 11a, 11b to which data streaming is carried out. Similarly to the user status memory 506, the output memory 503 is adapted to receive periodically from the pacing device 504 data, as indicated by the arrow M4 in FIG. 4, corresponding to information regarding the user device, i.e. stream, for which a read request is currently being sent to the memory unit 7. Based on this information, an output buffer 503a, 503b is identified for receiving the edited contents of the trimming device 505.

The second multiplexer 502 is also adapted to receive the control data sub-sets 105, and to extract, in dependence of the user status memory control, an edit portion of to each control data sub-set 105, according to an embodiment of the invention. As described further below, each extracted edit portion gives the address in the memory unit 7 of a subsequent payload data sub-set 92a, 92b. As indicated by the arrow E4 in FIG. 4, each edit portion of the control data sub-sets 101a, 101b is received by the pacing device 504.

The scheduling device 507 is adapted to determine the timing of data outputs from the output memory 503. As indicated by the line F4 in FIG. 4, the scheduling device 507 is adapted to read from data traffic from the output buffers 503a, 503b of the output memory 503 information based on which a bit-rate or a pace, at which the respective payload data flows are to be displayed, can be determined. More specifically, the bit-rate information is determined from known time codes, for example PCR (programme clock reference), used in multimedia display methods, and included in the payload data flows. The bit-rates corresponding to the respective time codes can differ from one payload data flow to another. Thus, the bit-rate of data streamed can differ from one output buffer 503a to another output buffer 503b.

The scheduling device 507 is adapted to control the data traffic from the output buffers 503a, 503b to the networking unit 4, as indicated by the arrow G4 in FIG. 4, in dependence on the bit-rate information for each stream. The data from each output buffer are sent in stream portions, the size of which is adapted to network requirements (e.g. in the order of 1.5 kB). More specifically, the scheduling device 507 is adapted to determine a bite-rate based on time codes in the payload data stream. The stream in question is sent based on this determined bit-rate, and when a further time code is detected, the determined bit-rate is compared to time information from a clock, and the scheduling device 507 is adapted to adjust, based on this comparison, the timing of data sent in the stream. If it is determined that a stream portion of data from one output buffer 503a, 503b should not be sent, the scheduling device 507 makes a similar determination concerning the another output buffer 503a, 503b, and works in this respect as a scheduler, performing a cyclic sequence of determinations whether to send stream portions of data from the respective output buffets 503a, 503b to the networking unit 4.

Referring to FIG. 2, the network unit 4 is adapted to receive stream portions from the respective output buffers 503a, 503b, as well as information identifying the respective output buffer 503a, 503b, and to create, in dependence on the streams served, data packets based on the stream portions from the output buffers 503a, 503b and the request data sets stored in the networking unit storage means 401. Thereby, the respective output buffer identification provides, or corresponds to an address in the networking unit storage means 401 of the corresponding request data set. The network unit 4 is further adapted to send the data packets to the to the user devices 11a, 11b via the network interface 4a. Thus, network data packets are created as the data is streamed by the streaming device 1.

Reference is made to FIG. 4. According to an embodiment of the invention, in a similar manner to the cyclic sequence of determinations performed by the scheduling device 507 whether to send stream portions of data from the respective output buffets 503a, 503b to the networking unit 4, the pacing device 504 is adapted to make a cyclic sequence of determinations regarding the data streams whether to send further read requests to the memory unit 7, and works in this respect as a scheduler for read instructions to the memory unit 7. As indicated in FIG. 4, each output buffer 503a, 503b is provided with a respective threshold level WMa, WMb in the respective FIFO queue. When determining whether to request more data for a specific output buffer 503a, 503b, the pacing device 504 is adapted to compare the amount of data temporarily stored in the output buffer to the respective threshold level WMa, WMb, and to request more data from the memory unit 7 if the amount of data stored is below the respective threshold level WMa, WMb. Thereby, as indicated by the arrow H4 in FIG. 4, based on the memory sector addresses in the control data sub-sets 105, the pacing device 504 sends to the memory unit 7 read requests for further payload data sub-sets 91-99 and a further control data sub-sets 105. Subsequent data sub-sets are received by the trimming device 505 and the multiplexers 501, 502, and data is forwarded to the output memory 503, in a manner corresponding to what has been described above.

It should be noted that the threshold levels WMa, WMb can be set individually and differently for the output buffers 503a, 503b, or to be the same for a group of output buffers or for all output buffers.

It should also be noted that, preferably, during a normal presentation mode 1×streaming process, read requests are sent by the editing unit 5 to the memory sectors 75 before the second control data portion 1052 has been stored in the respective memory sector 75. Thereby advantage is taken of the multi step storage procedure according to the invention, so that time delays, from reception of the payload data flows DC1-DC6 to streaming the payload data to user devices, are minimised.

During steaming of payload data, the networking unit 4 can receive a request from a user device for an alternative playback mode. The streaming device 1 is adapted to change the playback mode setting P11a, P11b for a user device 11a, 11b if the user device 11a, 11b requests an alternative playback mode, for example a trick-play mode, e.g., a fast forward mode or a fast reverse mode. More specifically, via the networking unit 4 and the control unit 6, the user status memory 506 in the editing unit 5 can receive a request, including the identity of the user device 11a, 11b, for an alternative playback mode.

Referring to FIG. 4, in trick-play modes, similarly to what has been described above, the editing unit 5 is adapted to retrieve, upon read instructions (H4) from the pacing device 504, payload data sub-sets 91-99, as well as control data sub-sets 105. Thereby, the trimming device 505 is adapted to receive and temporarily store the payload data sub-sets 91-99. The first multiplexer 501 is adapted to receive control data sub-sets 105 and extract an edit portion 105b-105g (FIG. 5b-5c) in accordance with the requested trick-play mode FW1, FW2, FW3, RW1, RW2, RW3, which edit portions gives linking information for the requested trick-play mode. As indicated by the arrow 174 in FIG. 4, the edit portions 105b-105g of the control data sub-sets 105 is used to read in the trimming device 505, so that a data sequence according to the linking structure of the respective edit portions is sent to the respective output buffers 503a, 503b of the output memory 503.

Thus, referring to 4, upon reception in the trimming device 505 of a payload data sub-set 91-99, the linking structure provided by an edit portion 105b-105g is used to extract a trimmed portion of the payload data sub-set 91-99 to be sent to the output buffer 503a, 503b for the stream in question. Parts of the payload data sub-set 91-99 excluded in the trimming device by the linking structure are simply deleted from the stream.

It should be mentioned that in addition to the streaming modes 1×, FW1, FW2, FW3, RW1, RW2, RW3 described above, in addition, the streaming device 1 can be adapted to stream data in a pause mode, whereby in a user device the presentation of moving pictures are frozen so that a non-moving image is shown. Thereby, the streaming unit 3 can be adapted to stream repeatedly the same identification data group IF1-IF7 to the user device in question.

1.-35. (canceled)

36. A method for data streaming comprising:
receiving a plurality of streaming requests from a plurality of user devices, and streaming data according to the streaming requests,
receiving a payload data flow,
storing the payload data flow during the reception of it,
detecting, during the reception of the payload data flow, a plurality of identification data groups in the payload data flow,
creating, at least partly based on the identification data groups, during the reception of the payload data flow, a plurality of control data portions, comprising data for linking at least some of the identification data groups, and
storing, during the reception of the payload data flow, the control data portions, wherein
a first control data portion for a first identification data group is stored before a second control data portion for the first identification data group is created.

37. A method according to claim 36, wherein the first control data portion comprises data for linking the first identification data group to a second identification data group preceding the first identification data group, and the second control data portion comprises data for linking the first identification data group to a third identification data group following the first identification data group, and wherein the payload data flow comprises data for displaying a sequence of images on the user devices, the first control data portion comprising data for linking at least some of the identification data groups for at least one reverse mode in the user device, and the second control data portion comprising data for linking at least some of the identification data groups for at least one fast forward mode in the user device.

38. A method according to claim 36, comprising creating, based on the payload data flow, a plurality of payload data subsets, wherein the step of storing the payload data flow comprises storing the payload data subsets in respective memory sectors in a memory unit, wherein the first control data portion is stored in a memory sector together with a payload data subset.

39. A method according to claim 36, comprising determining, at least partly based on the identification data groups, identification data group information, and wherein the step of creating a plurality of control data portions is carried out at least partly based on the identification data group information; and
creating, based on the payload data flow, a plurality of payload data subsets, wherein the identification data group information comprises information related to the locations in relation to respective payload data subsets.

40. A method according to claim 36, comprising creating, based on the payload data flow, a plurality of payload data subsets, wherein the step of storing the payload data flow comprises storing the payload data subsets in respective memory sectors in a memory unit, wherein the first control data portions comprises data for linking at least some of the payload data subsets in a normal presentation mode of the payload, and creating, before receiving the payload data flow, a memory sector address sequence for the payload data flow, and wherein the step of creating a plurality of control data portions is carried out at least partly based on the memory sector address sequence.

41. A method according to claim 36, wherein the first control data portion comprises data for streaming payload data in the payload data flow in a normal presentation mode, and the method comprising streaming payload data in the payload data flow in a normal presentation mode, and reading the first control data portion before the second control data portion is stored.

42. An apparatus for data streaming, adapted to
receive a plurality of streaming requests from a plurality of user devices, and to stream data according to the streaming requests,
receive a payload data flow,
store the payload data flow during the reception of it,
detect, during the reception of the payload data flow, a plurality of identification data groups in the payload data flow,
create, at least partly based on the identification data groups, during the reception of the payload data flow, a plurality of control data portions, comprising data for linking at least some of the identification data groups, and
store, during the reception of the payload data flow, the control data portions, the apparatus further being adapted to
store a first control data portion for a first identification data group before creating a second control data portion for the first identification data group.

43. An apparatus according to claim 42, wherein the first control data portion comprises data for linking the first identification data group to a second identification data group preceding the first identification data group, and the second control data portion comprises data for linking the first identification data group to a third identification data group following the first identification data group, and the payload data flow comprises data for displaying a sequence of images on the user devices, the first control data portion comprising data for linking at least some of the identification data groups for at least one reverse mode in the user device, and the second control data portion comprising data for linking at least some of the identification data groups for at least one fast forward mode in the user device.

44. An apparatus according to claim 42, adapted to create, based on the payload data flow, a plurality of payload data subsets, to store the payload data subsets in respective memory sectors in a memory unit, and to store the first control data portion in a memory sector together with a payload data subset.

45. An apparatus according to claim 42, adapted to determine, at least partly based on the identification data groups, identification data group information, and to create a plurality of control data portions based at least partly based on the identification data group information and adapted to create, based on the payload data flow, a plurality of payload data subsets, wherein the identification data group information comprises information related to the locations in relation to respective payload data subsets.

46. An apparatus according to claim 42, adapted to create, based on the payload data flow, a plurality of payload data subsets, and to store the payload data subsets in respective memory sectors in the memory unit, wherein the first control data portions comprises data for linking at least some of the payload data subsets in a normal presentation mode of the payload and adapted to create, before receiving the payload data flow, a memory sector address sequence for the payload data flow, and to create a plurality of control data portions at least partly based on the memory sector address sequence.

47. An apparatus according to claim 42, wherein the first control data portion comprises data for streaming payload data in the payload data flow in a normal resentation mode, and the apparatus being adapted to stream payload data in the payload data flow in a normal presentation mode, and to read the first control data portion before the second control data portion is stored.

48. An apparatus for data streaming, adapted to receive a plurality of streaming requests from a plurality of user devices, and to stream data according to the streaming requests, the apparatus comprising a streaming unit, a control unit, and a memory unit,
the streaming unit being adapted to receive at least one payload data flow, to store it in the memory unit during the reception of the payload data flow, to detect, during the reception of the payload data flow, a plurality of identification data groups in the payload data flow, to determine, at least partly based on the identification data groups, identification data group information, and to send, during the reception of the payload data flow, the identification data group information to the control unit, and
the control unit being adapted create, based at least partly on the identification data group information, during the reception of the payload data flow, control data for linking at least some of the identification data groups for data streaming in at least one trick play mode.

49. An apparatus according to claim 48, wherein the streaming unit is hard wired for receiving the payload data flow, for storing it in the memory unit, for detecting the identification data groups, for determining the identification data group information, and for sending the identification data group information to the control unit.

50. An apparatus according to claim 48, adapted to store a first control data portion for a first identification data group before creating a second control data portion for the first identification data group.

51. An apparatus according to claim 50, wherein the first control data portion comprises data for linking the first identification data group to a second identification data group preceding the first identification data group, and the second control data portion comprises data for linking the first identification data group to a third identification data group following the first identification data group, and wherein the payload data flow comprises data for displaying a sequence of images on the user devices, the first control data portion comprising data for linking at least some of the identification data groups for at least one reverse mode in the user device, and the second control data portion comprising data for linking at least some of the identification data groups for at least one fast forward mode in the user device.

52. An apparatus according to claim 48, adapted to create, based on the payload data flow, a plurality of payload data subsets, to store the payload data subsets in respective memory sectors in the memory unit, and to store the first control data portion in a memory sector together with a payload data subset.

53. An apparatus according to claim 48, adapted to determine, at least partly based on the identification data groups, identification data group information, and to create a plurality of control data portions based at least partly based on the identification data group information, and adapted to create, based on the payload data flow, a plurality of payload data subsets, wherein the identification data group information comprises information related to the locations in relation to respective payload data subsets.

54. An apparatus according to claim 48, adapted to create, based on the payload data flow, a plurality of payload data subsets, and to store the payload data subsets in respective memory sectors in the memory unit, wherein the first control data portions comprises data for linking at least some of the payload data subsets in a normal presentation mode of the payload, and to create, before receiving the payload data flow, a memory sector address sequence for the payload data flow, and to create a plurality of control data portions at least partly based on the memory sector address sequence.

55. An apparatus according to claim 48, wherein the first control data portion comprises data for streaming payload data in the payload data flow in a normal presentation mode, and the apparatus being adapted to stream payload data in the payload data flow in a normal presentation mode, and to read the first control data portion before the second control data portion is stored.
